(19) United States
(12) Patent Application Publication
(10) Pub. No.: US 2009/0017361 A1
(43) Pub. Date: Jan. 15, 2009

(54) SEPARATOR FOR FUEL CELL AND METHOD FOR FABRICATING THE SAME

(76) Inventors: Dae Soon Lim, Seoul (KR); Yang Bok Lee, Seoul (KR); Kwan Young Lee, Seoul (KR)

Correspondence Address: SCHMEISER, OLSEN & WATTS, 22 CENTURY HILL DRIVE, SUITE 302, LATHAM, NY, 12110, US

(21) Appl. No.: 12/171,440

(22) Filed: Jul. 11, 2008

(30) Foreign Application Priority Data
Jul. 13, 2007 (KR) 10 2007 0070467
May 28, 2008 (KR) 10 2008 0049836

(51) Int. Cl. H01M 2/00; B29C 43/18

(52) U.S. Cl. 429/34; 264/135

(57) ABSTRACT

A separator of fuel cells and a method for fabricating the same are disclosed. The separator includes a metal substrate, a carbon nanotube layer formed on the metal substrate by growing carbon nanotubes thereon, and a composite layer formed by coating a mixture of an electrically conductive additive and a polymer on the surface of the metal substrate by compression-molding, screen coating, dipping or tape casting, thereby preventing corrosion of the metal substrate while achieving a reduction in contact resistance which can generally be deteriorated when composites are coated on the metal substrate.

### CROSS-REFERENCE TO RELATED APPLICATION

The present application claims priority to Korean Patent Application Nos. 10-2007-0070467 filed on Jul. 13, 2007 and 10-2008-0049836 filed on May 28, 2008, the entire disclosure of which is incorporated herein by reference. The present invention was supported by the Seoul R&BD Program.

### BACKGROUND OF THE INVENTION

1. Field of the Invention

The present invention relates to a separator for polymer electrolyte fuel cells and a method for fabricating the same. More particularly, the present invention relates to a separator for polymer electrolyte fuel cells and a method for fabricating the same, which employs carbon composites prepared by adding polymer materials to carbon or an electrically conductive polymer, thereby achieving light weight, compactness and high corrosion resistance of the separator while allowing the separator to be fabricated by a simple process to reduce manufacturing costs thereof.

2. Description of the Related Art

Fuel cells are electrochemical energy conversion devices that generally convert chemical energy of hydrogen into electric energy through an electrochemical reaction.

In the fuel cell, hydrogen is generally supplied via an anode and is separated into hydrogen ions and electrons via oxidation by an electrode electrolyte.

Then, the hydrogen ions travel to a cathode through an electrolyte membrane, while the electrons travel to the cathode through an external circuit, so that the hydrogen ions and electrons react with oxygen to produce water via reduction at the cathode, thereby generating electric energy.

Such a fuel cell has a stack structure constituted by a body, a stack member, fuel supply and storage members, and other peripheral devices. Among these components of the the fuel cell, the stack member is one of the most essential components of the fuel cell and thus will be focused upon herein.

The stack member is composed of an electrolyte membrane, electrodes/electrolyte layers, a bipolar plate called a “separator,” and an end plate. Here, an assembly of the electrolyte membrane, electrolyte layers and electrodes is referred to as a “Membrane Electrode Assembly (MEA),” and the structure and performance of the MEA determine performance of the fuel cell.

Particularly, the electrolyte membrane acting as a passage of the hydrogen ions is an essential component of the fuel cell, and the fuel cell can be classified into five types according to the kind of electrolyte.

That is, the fuel cells can be classified into Molt Carbonate Fuel Cells (MCFC), Solid Oxide Fuel Cells (SOFC), Phosphoric Acid Fuel Cells (PAFC), Polymer Electrolyte Membrane Fuel Cells (or Proton Exchange Membrane Fuel Cells, PEMFC), and Direct Methanol Fuel Cells (DMFC). The MCFC and the SOFC operate at high temperatures, whereas the other fuel cells operate at relatively low temperatures.

A separator is a member that partitions unit cells of the fuel cell from one another to separate a fuel gas and air. The separator provides passages for supplying a fuel gas and air to the MEA and transferring electric current to the external circuit. For these reasons, the separator is required to have high electrical conductivity, corrosion resistance and thermal conductivity in addition to low gas permeability.

Conventionally, a graphite separator is prepared by milling graphite according to the shape of the passage. In this case, the separator consumes about 50% of the manufacturing costs and 80% of the weight of the entire fuel cell.

Since the graphite separator is prepared by the milling process, it requires high processing costs and cannot prevent mixture of gases due to a lower density. Accordingly, it is necessary for the graphite separator to have a predetermined thickness or more, which increases the size of the separator.

As such, the graphite separator has disadvantages of high manufacturing costs and size. To overcome such disadvantages of the conventional graphite separator, metal separators, electrically conductive polymer-based composite separators, and other composite separators having composite materials coated on a metal plate have been proposed to reduce the manufacturing costs while ensuring easy processibility.

The metal separators are generally based on stainless steel and show superior competitiveness in view of processibility, electrical conductivity, and price. However, since the stainless steel per se exhibits weak corrosion resistance, methods have been investigated to coat gold, platinum or tungsten, which exhibits high corrosion resistance, on the surface of the stainless steel plate in order to complement the weak corrosion resistance of the stainless steel. However, these methods also have problems of high processing costs due to the use of expensive metals.

Further, the composite separators have a disadvantage of fragility despite superior electrical conductivity.

### SUMMARY OF THE INVENTION

The present invention is conceived to solve the problems of the conventional techniques as described above, and an aspect of the present invention is to provide a separator for fuel cells and a method for fabricating the same, which includes a metal substrate, a carbon nanotube layer formed on the metal substrate by growing carbon nanotubes thereon, and a composite layer formed by coating a mixture of an electrically conductive additive and a polymer on the surface of the metal substrate by compression-molding, screen coating, dipping or tape casting, thereby preventing corrosion of the metal substrate while achieving a reduction in contact resistance which can generally be deteriorated when composites are coated on the metal substrate.

In accordance with one aspect of the present invention, a separator for fuel cells includes: an electrically conductive substrate; a carbon-nanotube layer formed on a surface of the substrate; and a composite layer covering the substrate having the carbon-nanotube layer formed thereon, the composite layer comprising a mixture of an electrically conductive additive and a polymer.

In accordance with another aspect of the present invention, a separator for fuel cells includes a substrate, the substrate comprising a metal plate, a first concave-convex shaped air or hydrogen passage formed on a first surface of the metal plate, and a second concave-convex shaped cooling water passage formed on a second surface of the metal plate, the second concave-convex of the second surface corresponding to the first concave-convex on the first surface; a carbon-nanotube layer formed over the entire surface of the substrate; and a composite layer formed on the substrate and comprising a mixture of an electrically conductive additive and a polymer.

The substrate may include an electrically conductive metal selected from stainless steel, aluminum, copper, and combinations thereof.

The substrate may have a thickness of 0.01˜3 mm. The carbon nanotube layer may have a thickness of 1˜500 μm.

The polymer may include a material selected from an epoxy resin, a phenolic resin, a furan resin, vinyl ester, polypropylene, polyvinylidene fluoride, polyethylene, polyphenylene sulfide, polyphenylene oxide, polyaniline, polypyrrole, and combinations thereof.

The electrically conductive additive may be mixed with the polymer in the composite layer and be electrically connected to the carbon nanotube layer.

The electrically conductive additive may include a material selected from carbon black, graphite, carbon fiber, carbon nanotubes, Ag-coated copper, and combinations thereof.

The electrically conductive additive may comprise 30˜60 weight % and the polymer may comprise 40˜70 weight % with respect to a total weight of the mixture of the electrically conductive additive and the polymer.

The composite layer may have a thickness of 10 μm˜3 mm.

In accordance with a further aspect of the present invention, a method for fabricating a separator for fuel cells includes: preparing a substrate and a composite material formed by mixing an electrically conductive additive with a polymer; forming a carbon-nanotube layer by growing carbon-nanotubes on the substrate; and forming a composite layer on the substrate by covering the substrate having the carbon-nanotube layer thereon with the composite material using a compression-molding device.

In accordance with yet another aspect of the present invention, a method for fabricating a separator for fuel cells includes: forming a substrate, the substrate comprising a metal plate, a first concave-convex shaped air or hydrogen passage formed on a first surface of the metal plate, and a second concave-convex shaped cooling water passage formed on a second surface of the metal plate, the second concave-convex of the second surface corresponding to the concave-convex shape on the first surface; forming a carbon-nanotube layer on the substrate by growing carbon nanotubes over the entire surface of the substrate; and forming a composite layer comprising a mixture of an electrically conductive additive and a polymer on the carbon-nanotube layer.

The substrate may include an electrically conductive metal selected from stainless steel, aluminum, copper, and combinations thereof.

The substrate may have a thickness of 0.01˜3 mm.

The formation of a carbon-nanotube layer may include growing the carbon nanotubes to a thickness of 1˜500 μm on the surface of the substrate by performing chemical vapor deposition for 2 to 60 minutes.

The polymer may include a material selected from an epoxy resin, a phenolic resin, a furan resin, vinyl ester, polypropylene, polyvinylidene fluoride, polyethylene, polyphenylene sulfide, polyphenylene oxide, polyaniline, polypyrrole, and combinations thereof.

The polymer may include a material exhibiting thermal resistance to temperatures from 10˜200° C.

The electrically conductive additive may be mixed with the polymer in the composite layer and be electrically connected to the carbon nanotube layer.

The electrically conductive additive may include a material selected from carbon black, graphite, carbon fiber, carbon nanotubes, Ag-coated copper, and combinations thereof.

The composite layer may be formed by one selected from painting, screen coating, dipping, and tape casting.

The electrically conductive additive may be 30˜60 weight % and the polymer may be 40˜70 weight % with respect to a total weight of the mixture of the electrically conductive additive and the polymer.

The composite layer may be formed to a thickness of 10 μm˜3 mm.

The separator may have a contact resistance of 10˜100 mΩcm².

The separator may have a bending strength of 56 MPa or more.

### BRIEF DESCRIPTION OF THE DRAWINGS

The above and other features and advantages of the present invention will become apparent from the following description of exemplary embodiments given in conjunction with the accompanying drawings, in which:

FIG. 1 is a cross-sectional view of a separator for fuel cells according to one embodiment of the present invention;

FIGS. 2a to 2d show a method for fabricating a separator for fuel cells according to one embodiment of the present invention;

FIG. 3 is a micrograph showing a cross-section of a separator for fuel cells according to one embodiment of the present invention;

FIGS. 4a and 4b are micrographs of a carbon nanotube layer of a separator for fuel cells according to one embodiment of the present invention;

FIG. 5 is a graph depicting contact resistance of a separator for fuel cells according to one embodiment of the present invention;

FIG. 6 is a graph depicting bending strength of a separator for fuel cells according to one embodiment of the present invention;

FIG. 7 is a plan view of a separator for fuel cells according to one embodiment of the present invention;

FIGS. 8a and 8b are schematic sectional views showing a screen coating process according to the present invention and a separator for fuel cells fabricated by the same;

FIG. 9 is an electron micrograph of a separator containing 10 wt. % carbon black according to one embodiment of the present invention;

FIG. 10 is an electron micrograph of a separator containing 30 wt. % carbon black according to one embodiment of the present invention;

FIG. 11 is a graph for measuring corrosion resistance of a separator for fuel cells according to one embodiment of the present invention; and

FIG. 12 is a graph depicting contact resistance of a separator for fuel cells according to one embodiment of the present invention.

### DETAILED DESCRIPTION OF THE INVENTION

Exemplary embodiments of the present invention will hereinafter be described in detail with reference to the accompanying drawings. The embodiments are given by way of illustration for full understanding of the present invention by those skilled in the art. Hence, the present invention is not limited to these embodiments and can be realized in various forms. Herein, like components will be denoted by like reference numerals throughout the specification and the accompanying drawings.

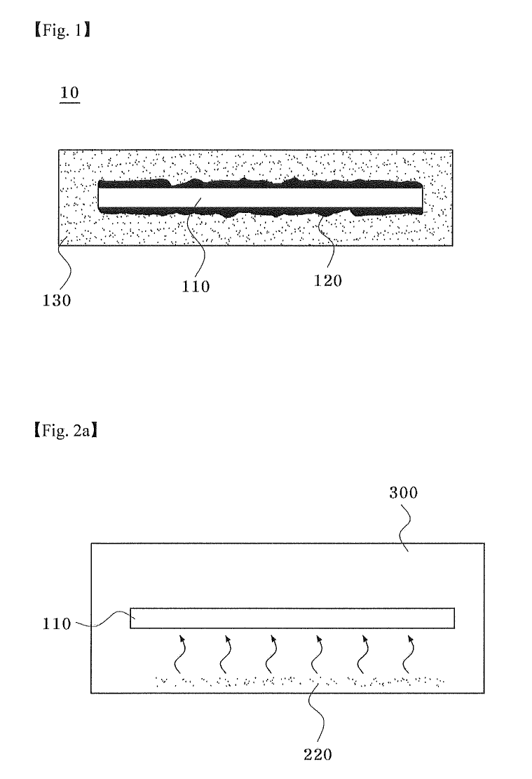

FIG. 1 is a cross-sectional view of a separator for fuel cells according to one embodiment of the present invention.

Referring to FIG. 1, the separator 10 for fuel cells includes a substrate 110, a carbon-nanotube layer 120 formed on the surface of the substrate 110, and a composite layer 130 covering the substrate 110 which has the carbon-nanotube layer 120 formed thereon.

The substrate 110 may comprise a material selected from stainless steel, aluminum (Al), copper (Cu), and combinations thereof. The substrate may have a thickness of 0.01˜3 mm.

The carbon-nanotube layer 120 is formed on the surface of the substrate 110. The carbon-nanotube layer 120 serves to reduce contact resistance of the separator 10, and may comprise a material selected from carbon black, carbon nanotubes (CNT), carbon fiber (CNF), graphite and combinations thereof.

For the composite layer 130, composites may be formed by mixing a polymer and an electrically conductive additive. Then, the composite layer 130 can be formed by compression molding the composites to cover the substrate 110 on which the carbon-nanotube layer 120 is formed.

The polymer can enhance corrosion resistance of the separator 10. Further, the polymer facilitates formation of a passage on the surface of the separator 10.

The polymer may comprise a thermosetting polymer selected from an epoxy resin, a phenolic resin, a furan resin, vinyl ester, and combinations thereof.

Further, the polymer may comprise a thermoplastic polymer selected from polypropylene, polyvinylidene fluoride, polyethylene, polyphenylene sulfide, polyphenylene oxide, and combinations thereof.

The polymer may exhibit thermal resistance to temperatures from 10˜200° C.

Some of the electrically conductive additive mixed with the polymer is connected to the carbon-nanotube layer 120, thereby improving the contact resistance of the separator 10.

The electrically conductive additive may comprise a material selected from carbon black, graphite, carbon fiber, carbon nanotubes, Ag-coated copper, and combinations thereof.

In this manner, the separator 10 for fuel cells may have improved corrosion resistance by the polymer and may have improved electrical conductivity by the carbon-nanotube layer 120 and the electrically conductive additive mixed with the polymer.

Further, the substrate 110 is formed of metal, thereby improving bending strength of the separator 10.

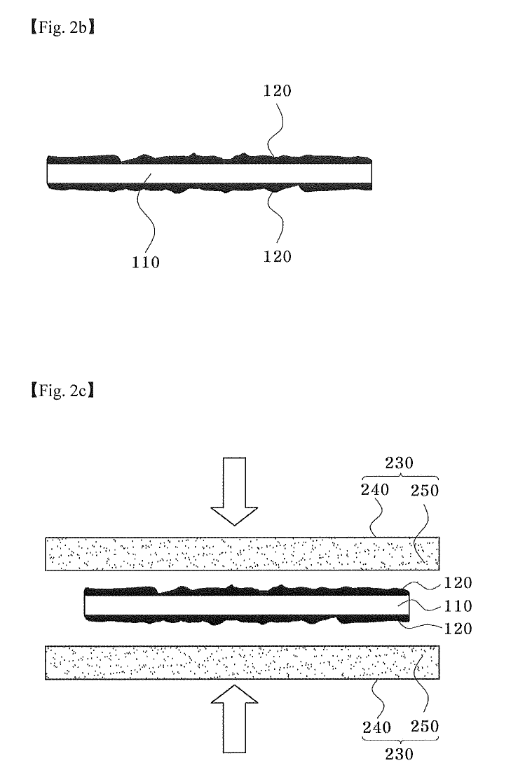

FIGS. 2a to 2d show a method for fabricating a separator for fuel cells according to one embodiment of the present invention. In the description of the method depicted in FIGS. 2a to 2d, the separator will be described with reference to FIG. 1 and the components described in FIG. 1 will be described briefly or omitted herein.

As shown in FIG. 2a, first, a substrate 110 is prepared to fabricate the separator for fuel cells.

The substrate 110 may comprise a metal selected from stainless steel, aluminum (Al), copper (Cu), and combinations thereof, which exhibit electrical conductivity. As such, by forming the substrate 110 with the metal, it is possible to improve bending strength and other properties of the separator while ensuring electrical conductivity thereof.

Then, carbon nanotubes 220 are grown on the surface of the substrate 110.

The carbon nanotubes 220 can be grown on the substrate 110 using a variety of processes. For Example 1 described below, the carbon nanotubes 220 are grown on the substrate 110 using a chemical vapor deposition (CVD) apparatus 300.

Specifically, with the substrate 110 loaded into a closed tube made of quartz or the like, the carbon nanotubes 220 are grown on the substrate 110 by the CVD apparatus 300 which has a bubbler.

Referring to FIG. 2a, the carbon nanotubes 220 are grown on the substrate 110 by CVD in the CVD apparatus 300.

Here, the carbon nanotubes 220 are deposited on the surface of the substrate 110 for 10 to 60 minutes to form a carbon-nanotube layer 120 having a predetermined thickness.

Meanwhile, composites 230 can be prepared before forming a composite layer 130 (see FIG. 2d), which will be formed later in a compression molding process. The composites 230 may be formed by mixing a polymer 240 and an electrically conductive additive 250, followed by uniformly dispersing the mixture on the substrate 110 with a kneader.

In this embodiment, the composites 230 are prepared at this step. However, the present invention is not limited thereto, and the composites 230 may be prepared at any step to prepare materials for the separator.

Then, as shown in FIG. 2c, the composites 230 are subjected to a compression-molding process with a compression-molding device. At this time, the composites 230 are disposed such that the substrate 110 having the carbon-nanotube layer 120 thereon is disposed between the composites 230.

The compression molding device can form the composite layer 130 to cover the substrate 110 by applying pressure to the composites 230.

Here, the thickness of the composite layer 130 can be adjusted depending on the pressure applied to the composites 230. The composite layer 130 may have a thickness of 3 mm or less.

Further, the pressure applied to the composites 230 can be varied depending on the kind of polymer 240 used for the composites 230.

Then, the separator 10 for fuel cells can be obtained as shown in FIG. 2d.

The composite layer 130 is formed on the surface of the separator 10, thereby improving the corrosion resistance of the separator 10. Here, the electrically conductive additive 250 contained in the composite layer 130 is electrically connected to the carbon-nanotube layer 120, thereby improving electrical conductivity of the separator 10.

In this manner, the method for fabricating the separator for fuel cells according to the present invention facilitates thickness adjustment of the separator 10 and can reduce the thickness of the separator 10 to improve power density of the separator 10.

Further, the method according to the invention enables mass production of the separator 10 for fuel cells by the simple compression-molding process as described above.

Next, examples and embodiments of the separator for fuel cells according to the present invention will also be described with reference to FIGS. 2a to 2d, but a repeated description of components will be omitted herein.

### EXAMPLE 1

Analysis of Microstructure

In Example 1, polypropylene was prepared as the polymer 240 and carbon black was prepared as the electrically conductive additive 250 for the composites 230. Then, polypropylene and carbon black were mixed for 20 minutes using a kneader to form the composites 230.

After preparing two pieces of composites in this manner, a substrate having a carbon nanotube layer 120 formed thereon was disposed between the pieces of composites, and compression molding was performed to apply pressure to each of the composites 230 in both upward and downward directions.

As a result, a separator 10 for fuel cells according to Example 1 was obtained.

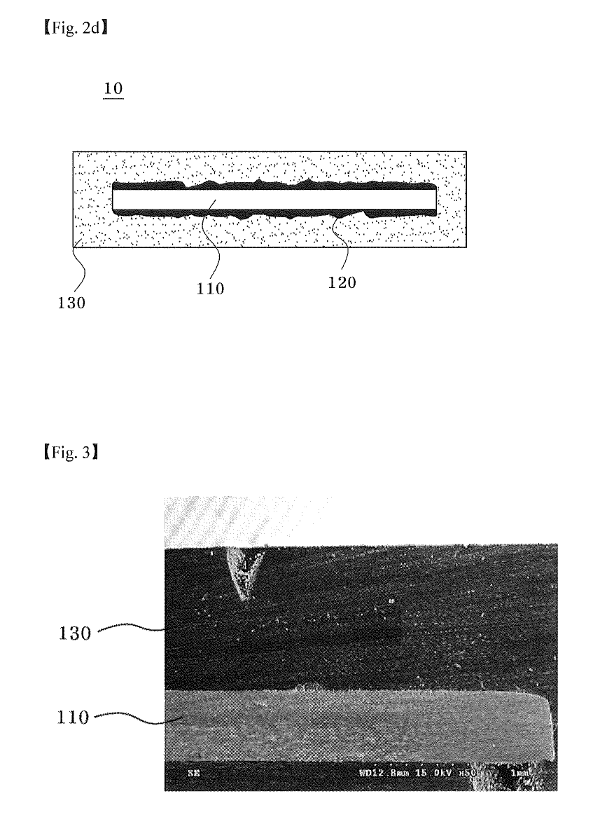

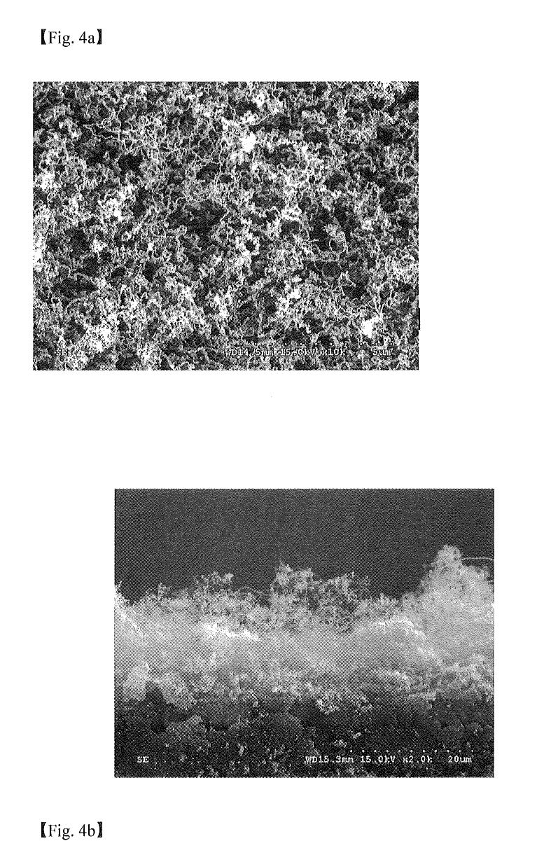

FIG. 3 is a micrograph showing a cross-section of the separator for fuel cells of Example 1 according to the present invention.

Referring to FIG. 3, the separator 10 has the composites 230 which cover the substrate 110.

According to the present invention, the substrate 110 may have a thickness of 0.01˜3 mm, and the carbon nanotube layer (not shown) formed on the substrate may be grown to a grown to a thickness of 1˜500 μm, and more preferably to a thickness of 1˜50 μm.

Further, the composite layer 130 covering the substrate 110 may be formed to a thickness of 3 mm or less by applying pressure to the composites 230 in order to improve power density of the separator for fuel cells.

In this example, carbon nanotubes were grown on the surface of the substrate 110 for 30 minutes by CVD.

In addition to CVD, thermal deposition can be employed to grow the carbon nanotubes, and time for growth can be suitably adjusted to achieve a desired thickness of the carbon nanotube layer.

FIGS. 4a and 4b are micrographs of a carbon nanotube layer of a separator for fuel cells according to one embodiment of the present invention.

Here, FIG. 4a is a plan view of the carbon nanotube layer formed on the surface of the substrate, and FIG. 4b is a cross-sectional view of the carbon nanotube layer formed on the surface of the substrate.

As shown in FIGS. 4a and 4b, the carbon nanotubes are grown to a thickness of 20 μm on the surface of the substrate for 30 minutes by CVD, and improved the contact resistance of the separator for fuel cells.

Analysis of Bending Strength and Contact Resistance

The separator of Example 1 prepared as described above was subjected to measurement of bending strength and contact resistance.

As standard contact resistance and corrosion current of a separator for fuel cells, the Department of Energy (DOE) suggests 20 mΩ cm² or less and 1 μA/cm² or less, respectively.

FIG. 5 is a graph depicting contact resistance of a separator for fuel cells according to one embodiment of the present invention.

In FIG. 5, (a) shows the contact resistance of the separator for fuel cells with the carbon nanotube formed on the substrate of Example 1, and (b) shows contact resistance of a conventional separator for fuel cells with a composite layer formed on a substrate.

Here, since the composites for the composite layer were formed by mixing the electrically conductive additive with the polymer, the composite layer exhibited a certain contact resistance.

Referring to FIG. 5, the separator of Example 1 shown in (a) had improved contact resistance above the conventional separator shown in (b).

As shown in FIG. 5, the separator for fuel cells according to the present invention has a contact resistance of 10˜15 mΩ cm². That is, it can be appreciated that the separator for fuel cells according to the present invention has a contact resistance three times or more of the conventional separator.

It is considered that such an improvement in contact resistance of the separator for fuel cells of the present invention was caused by the carbon nanotube layer formed on the substrate.

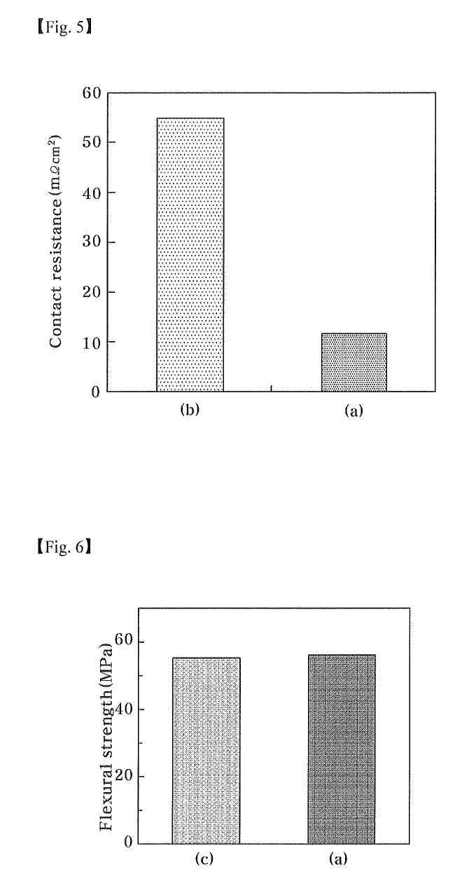

FIG. 6 is a graph depicting bending strength of the separator for fuel cells according to one embodiment of the present invention.

In FIG. 6, (a) shows the bending strength of the separator for fuel cells according to Example 1 of the present invention, and (c) shows bending strength of the conventional separator for fuel cells.

The conventional separator shown in (c) of FIG. 6 is a metal separator and has a bending strength of 50˜60 MPa. However, since the conventional separator employed the composites, the conventional separator was susceptible to deterioration in bending strength. In other words, since the composites do not provide a satisfactory bending strength, the composites are not well suited for the separator.

Conversely, as shown in (a) of FIG. 6, since the separator for fuel cells according to the present invention includes the metal substrate as a matrix layer and the composite layer covering the metal substrate, the separator has the same or improved bending strength as compared to the conventional metal separator.

Meanwhile, when producing a fuel cell with the separator, it is necessary to form a passage on the composite layer. At this time, since the composite layer contains the polymer and the electrically conductive additive mixed therewith, the passage can be easily formed on the composite layer. Therefore, the composite layer of the separator according to the present invention can improve processibility of the fuel cell.

Next, a separator for fuel cells and a method for fabricating the same will be described in more detail with reference to other embodiments.

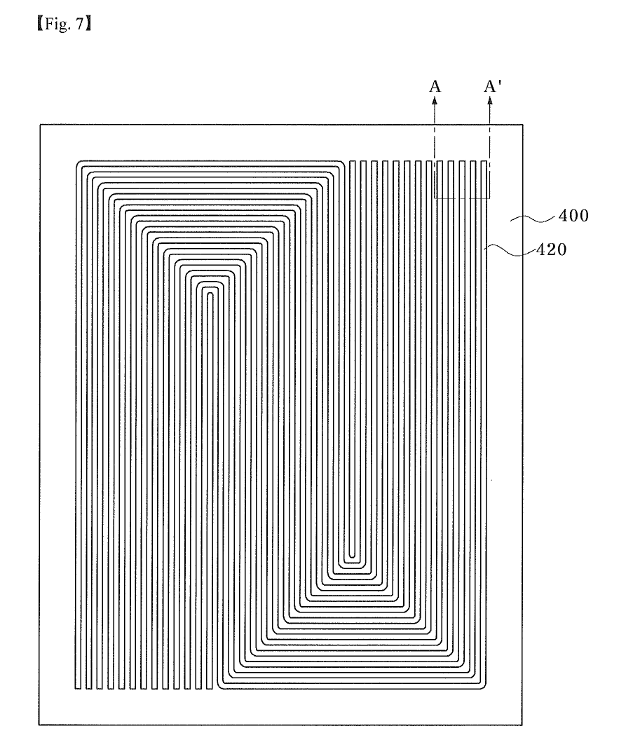

FIG. 7 is a plan view of a separator for fuel cells according to another embodiment of the present invention.

Referring to FIG. 7, a substrate 400 constituting a main body of the separator is prepared using a metal plate, In Embodiment, a stainless steel plate. Herein, upper and lower surfaces of the plate will be defined as first and second surfaces, respectively. In FIG. 7, the first surface of the plate is shown.

On the first surface of the metal plate, a concave-convex shape 420 is formed by alternately disposing embossed-engraved patterns thereon, in which recesses defined between the embossed patterns define an air or hydrogen passage. Specifically, when the concave-convex shape 420 is constituted by the embossed patterns, a region between the embossed patterns defines the air or hydrogen passage. Conversely, when the concave-convex shape 420 is constituted by the engraved patterns, the engraved patterns define the air or hydrogen passage.

Further, on the second surface of the substrate opposite the first surface, engraved-embossed patterns are alternately formed so as to correspond to the embossed-engraved patterns of the concave-convex shape 420 such that recesses defined thereby serves as a cooling water passage (not shown).

As such, the air or hydrogen passage is formed by stamping a metal plate. Generally, for application of the metal plate to the separator for fuel cells, two metal plates are stamped as described above and brought into contact with each other such that the second surface of one metal plate faces the second surface of the other.

According to the present invention, the separator does not require two metal plates. Instead, the present invention can employ one metal plate 400 for the separator for fuel cells, and the separator for fuel cells will be described as including one metal plate herein.

As described above, the separator according to the present invention includes the substrate, the carbon nanotube layer formed on the surface of the substrate, and the composite layer formed on the carbon nanotube layer and comprising the mixture of the electrically conductive additive and the polymer.

Here, the substrate may comprise a metal selected from stainless steel, aluminum (Al), copper (Cu), and combinations thereof, which have electrical conductivity. The polymer may comprise one material selected from an epoxy resin, a phenolic resin, a furan resin, vinyl ester, polypropylene, polyamideimide (PAI), polyvinylidene fluoride, polyethylene, polyphenylene sulfide, polyphenylene oxide (PPO), polyaniline, polypyrrole, and combinations thereof. Further, the additive may comprise a material selected from carbon black, graphite, carbon fiber, carbon nanotubes, Ag-coated copper, and combinations thereof. Table 1 shows each embodiment of the substrate, polymer and electrically conductive additive for ensuring optimal properties for the separator.

TABLE 1

| | Substrate | Polymer | Additive |
|---|---|---|---|
| Material | stainless steel | polyphenylene oxide (PPO) | carbon black |
| | Cu | polyamideimide (PAI) | carbon fiber |
| | Al | polyaniline | graphite |
| | | polypyrrole | carbon nanotube |

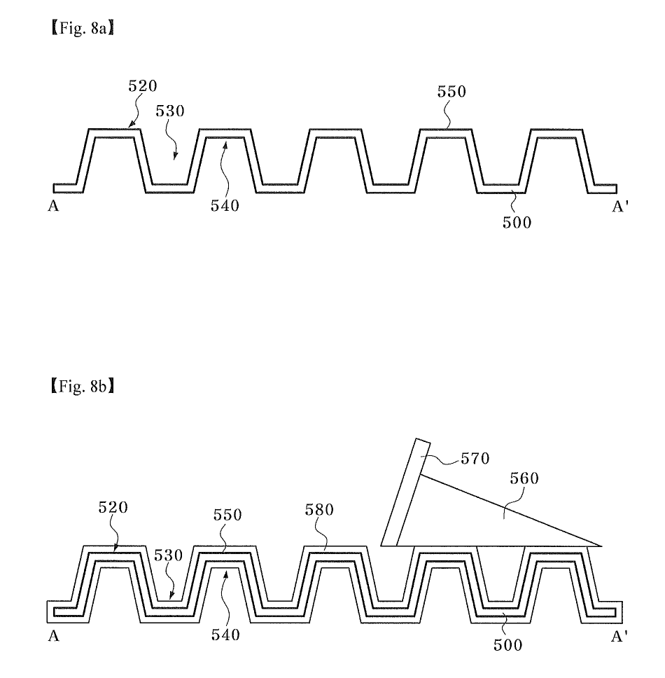

FIGS. 8a and 8b are schematic sectional views taken along line A-A′ of FIG. 7, illustrating a screen coating process according to the present invention and a separator for fuel cells fabricated by the same.

Referring to FIG. 8a, an electrically conductive substrate 500 is prepared as a main body of a separator for fuel cells. Here, the substrate 500 may be formed of a metal selected from stainless steel, aluminum, copper, and combinations thereof, which have electrical conductivity. The substrate 500 may have a thickness of 0.01˜3 mm.

The substrate 500 has embossed patterns 520 and engraved patterns 530 alternately disposed thereon. Here, on an upper surface (that is, first surface) of the substrate 500, the engraved patterns 530 define an air or hydrogen passage. Air or hydrogen is supplied into the fuel cell through the passage, while water generated during electrochemical reaction for generating electricity is discharged through the passage. Since an increase in the number of passages leads to an improvement in efficiency of the fuel cell, as many of the embossed and engraved patterns 520 and 530 as possible are formed on the surface of the substrate, as shown in FIG. 7. Further, recesses 540 defined on a lower surface of the substrate (that is, second surface) by the embossed and engraved patterns 520 and 530 formed on the upper surface of the substrate constitute a cooling water passage of the fuel cell. In this manner, since the substrate 500 is exposed to gas and water, it is susceptible to corrosion.

To prevent corrosion of the substrate, a carbon nanotube layer 550 is formed on the entire surface of the substrate 500 by growing carbon nanotubes. The carbon nanotube layer 550 may be formed to a thickness of 1˜500 μm on the surface of the substrate 500 by performing chemical vapor deposition for 2 to 60 minutes.

When the carbon nanotube layer 550 is formed on the substrate, it is possible to obtain a significant reduction in contact resistance which can be generated during formation of a composite layer in a subsequent process. When the contact resistance is significantly reduced, a bonding force between the composite layer and the metal plate can be increased.

Referring to FIG. 8b, a composite layer 580 composed of a mixture of a polymer and an electrically conductive additive is formed on the carbon nanotube layer 550. At this time, the composite layer 580 is formed of composites 560 that are prepared by mixing the polymer and the electrically conductive additive. Here, the electrically conductive additive may be added in an amount of 30˜60 weight % and the polymer may be added in an amount of 40˜70 weight % with respect to a total weight of the composite material 560.

Then, the composite material 560 is coated on the carbon nanotube layer 550. Specifically, the composite material 560 is coated to a thickness of 10˜500 μm, and more preferably to a thickness of 100 μm or less, using a molding device 570 to perform one selected from painting, screen coating, dipping, and tape casting.

The polymer may comprise a material selected from an epoxy resin, a phenolic resin, a furan resin, vinyl ester, polypropylene, polyvinylidene fluoride, polyethylene, polyphenylene sulfide, polyphenylene oxide, polyaniline, polypyrrole, and combinations thereof. Further, it is desirable that the polymer exhibit thermal resistance to temperatures from 10˜200° C. to prevent the separator from being weakened by heat which can be generated from the fuel cell.

The electrically conductive additive is added to the composites such that the additive can be electrically connected to the carbon nanotube layer when the composite layer 580 covers the carbon nanotube layer. The electrically conductive additive may comprise a material selected from carbon black, graphite, carbon fiber, carbon nanotubes, Ag-coated copper, and combinations thereof. Hereinafter examples of the separator for fuel cells according to the present invention will be described, in which carbon black is used as the electrically conductive additive.

### EXAMPLE 2

In Example 2, polyamideimide (PAI) was prepared as a polymer and carbon black with carbon fiber was prepared as an electrically conductive additive.

First, polyamideimide (PAI) was prepared in powder form by using a milling machine and was dissolved in NMP (N-methylpyrrolidone), followed by addition of carbon black to the resultant solution, thereby forming a coating solution for forming a composite layer. In this regard, according to the present invention, carbon black may be added in an amount of 30˜50 weight % , carbon fiber may be added in an amount of 1˜10 weight % and polyamideimide may be added in an amount of 40˜70 weight % with respect to a total weight of the mixture of carbon black and polyamideimide.

Here, an increase in added amount of carbon black leads to a reduction in contact resistance of the separator but results in a lower viscosity causing unsatisfactory coating. Thus, the added amounts of carbon black and polyamideimide are determined as described above. Further, since a lower size of the polymer powder allows more efficient dissolution of the polymer in a solution, it is important to use a very fine polymer powder. Mixing carbon black, carbon fiber and polyamideimide is performed at room temperature, and may be performed for 60 to 120 minutes.

Further, viscosity of the coating solution can adjusted by the amount of NMP (N-methylpyrrolidone) added. Namely, when coating the solution by painting, coating characteristics can be improved by adjusting the viscosity of the coating solution to 35,000˜50,000 cP, and when coating the solution by screen coating, coating characteristics can be improved by adjusting the viscosity of the coating solution to 10,000˜30,000 cP. Additionally, productivity can be improved by adjusting the viscosity of the coating solution depending on the kind of process such as dipping or tape casting.

Then, a carbon nanotube layer was formed on the surface of stainless steel SUS304 coated with hydrofluoric acid (HF), followed by screen printing the coating solution on the carbon nanotube layer, thereby forming the composite layer.

### EXAMPLE 3

Example 3 was prepared according to the same process as that of Example 2 except that the amount of carbon black in the coating solution was reduced.

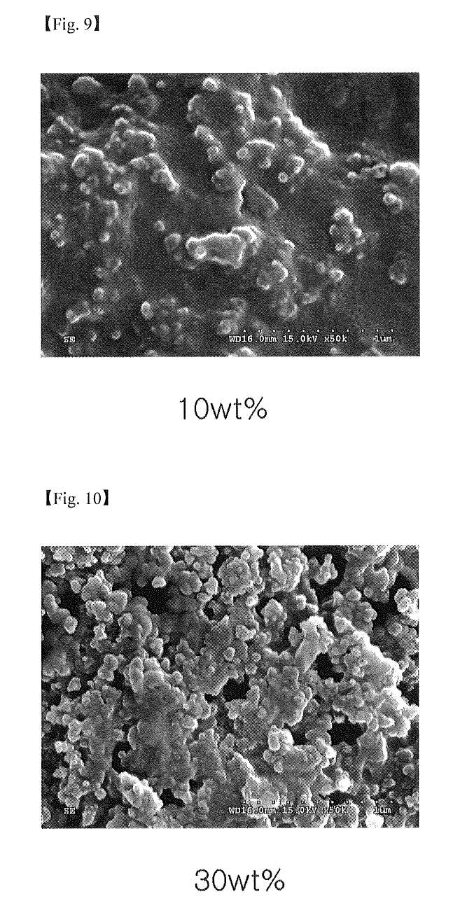

FIG. 9 is an electron micrograph of a separator containing 10 weight % of carbon black according to the present invention, and FIG. 10 is an electron micrograph of a separator containing 30 weight % of carbon black according to the present invention.

A specimen containing the smaller amount of carbon black exhibited superior corrosion characteristics, but exhibited high contact resistance, so that it could not be used as a separator for fuel cells. On the contrary, a specimen containing 30 weight % carbon black (FIG. 10) had improved corrosion characteristics due to a surface state and exhibited a low contact resistance.

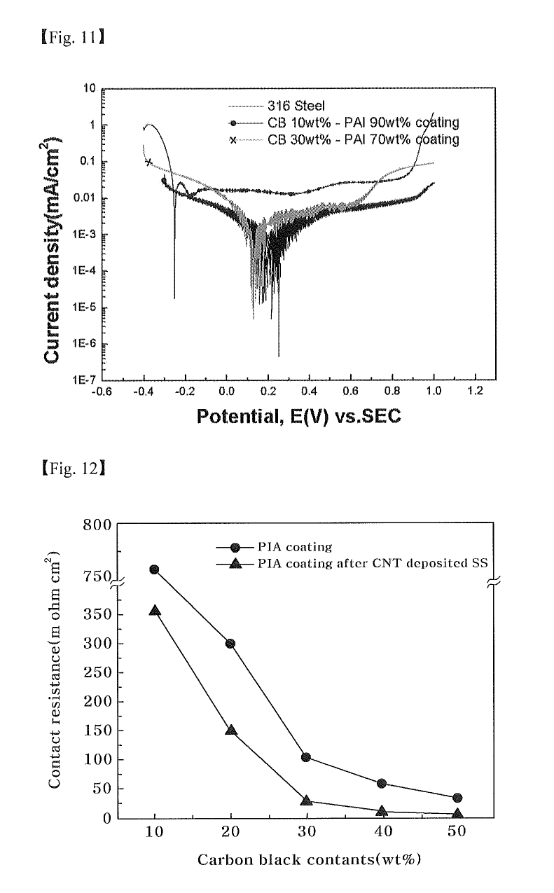

As such, when the coating solution contained only a small amount of carbon black, the separator could not be used due to high electrical conductivity, which will be described in more detail with reference to FIGS. 11 and 12.

FIG. 11 is a graph for measuring corrosion resistance of a separator for fuel cells according to one embodiment of the present invention.

As can be seen from FIG. 11, the separator formed by coating a solution containing 30 weight % carbon black and 70 weight % polyamideimide (CB 30 weight %-PAI 70 weight % coating) as in Example 2 on the surface of a cathode section where a potential of 0.6 V per second is applied has a lower current density between −0.1V˜0.6V than that of a 316 stainless steel-based separator. Thus, it can be appreciated that Example 2 has a high corrosion resistance.

For the 316 stainless steel based separator, as the surface of 316 stainless steel is exposed to an acid electrolyte, Fe on the surface is selectively corroded and eluted to form a Cr-rich surface, so that Cr on the surface is oxidized into Cr₂O₃ to form a passive layer acting as a resistor, thereby increasing the corrosion resistance. Since the passive layer is actively formed in an oxygen atmosphere, the passive layer is most frequently formed in a space between an electrode and a gasket directly contacting an electrolyte membrane in a fuel cell. Further, the passive layer is also frequently formed near the cathode where oxidation occurs, thereby causing resistance reduction and durability deterioration. Conversely, as in Example 2, the separator according to the present invention does not suffer from such problems of the 316 stainless steel based separator. Improved contact resistance characteristics of the separator according to the present invention as described in FIG. 8 can be verified from FIG. 12.

FIG. 12 is a graph depicting contact resistance of a separator for fuel cells according to one embodiment of the present invention.

As shown in FIG. 12, an increase in added amount of carbon black leads to a decrease in contact resistance. Further, the separator formed by coating PIA after growing the carbon nanotubes has a lower contact resistance (indicated by mark -▴- ) than that of the separator formed by coating PIA without growing the carbon nanotubes (indicated by mark -- ).

As apparent from the above description, the separator for fuel cells according to the present invention includes a metal substrate, an electrically conductive carbon nanotube layer and an electrically conductive composite layer, which are sequentially formed on a metal substrate, so that the separator has improved contact resistance and bending strength. Accordingly, a fuel cell including the separator of the present invention has improved contact resistance, which improves output of the fuel cell. Further, the separator for polymer electrolyte fuel cells according to the present invention employs the metal substrate to withstand mechanical impact and has an electrically conductive polymer coated thereon to improve corrosion resistance. Further, the separator for fuel cells according to the present invention has a composite layer containing 50 weight % or less of carbon black as the electrically conductive additive and coated by painting, whereby the composite layer can be very thinly formed as compared to the conventional separator. Accordingly, the separator has a very low contact resistance and mass production thereof can be implemented without deteriorating productivity.

Although the present invention has been described with reference to the embodiments and the accompanying drawings, the invention is not limited to the embodiments and the drawings. It should be understood that various modifications and changes can be made by those skilled in the art without departing from the spirit and scope of the present invention as defined by the accompanying claims. The embodiments have been disclosed for illustrative purposes and the scope of the invention should be determined by the accompanying claims.

What is claimed is:

1. A separator for fuel cells, comprising:
an electrically conductive substrate;
a carbon-nanotube layer formed on a surface of the substrate; and
a composite layer covering the substrate having the carbon-nanotube layer formed thereon, the composite layer comprising a mixture of an electrically conductive additive and a polymer.

2. A separator for fuel cells, comprising:
a substrate, the substrate comprising a metal plate, a first concave-convex shaped air or hydrogen passage formed on a first surface of the metal plate, and a second concave-convex shaped cooling water passage formed on a second surface of the metal plate, the second concave-convex of the second surface corresponding to the first concave-convex on the first surface;
a carbon-nanotube layer formed over the entire surface of the substrate; and
a composite layer formed on the carbon-nanotube layer and comprising a mixture of an electrically conductive additive and a polymer.

3. The separator for fuel cells according to claim 1, wherein the substrate comprises an electrically conductive metal selected from stainless steel, aluminum, copper, and combinations thereof.

4. The separator for fuel cells according to claim 1, wherein the substrate has a thickness of 0.01˜3 mm.

5. The separator for fuel cells according to claim 1, wherein the carbon nanotube layer has a thickness of 1˜500 μm.

6. The separator for fuel cells according to claim 1, wherein the polymer comprises a material selected from an epoxy resin, a phenolic resin, a furan resin, vinyl ester, polypropylene, polyvinylidene fluoride, polyethylene, polyphenylene sulfide, polyphenylene oxide, polyaniline, polypyrrole, and combinations thereof.

7. The separator for fuel cells according to claim 1, wherein the electrically conductive additive is mixed with the polymer in the composite layer and is electrically connected to the carbon nanotube layer.

8. The separator for fuel cells according to claim 1, wherein the electrically conductive additive comprises a material selected from carbon black, graphite, carbon fiber, carbon nanotubes, Ag-coated copper, and combinations thereof.

9. The separator for fuel cells according to claim 1, wherein the electrically conductive additive comprises 30˜60 weight % and the polymer comprises 40˜70 weight % with respect to a total weight of the mixture of the electrically conductive additive and the polymer.

10. The separator for fuel cells according to claim 1, wherein the composite layer has a thickness of 10 μm˜3 mm.

11. A method for fabricating a separator for fuel cells, comprising:
preparing a substrate and a composite material formed by mixing an electrically conductive additive with a polymer;
forming a carbon-nanotube layer by growing carbon-nanotubes on the substrate; and
forming a composite layer on the substrate by covering the substrate having the carbon-nanotube layer thereon with the composite material using a compression-molding device.

12. A method for fabricating a separator for fuel cells, comprising
forming a substrate, the substrate comprising a metal plate, a first concave-convex shaped air or hydrogen passage formed on a first surface of the metal plate, and a second concave-convex shaped cooling water passage formed on a second surface of the metal plate, the second concave-convex of the second surface corresponding to the first concave-convex on the first surface;
forming a carbon-nanotube layer on the substrate by growing carbon nanotubes over the entire surface of the substrate; and
forming a composite layer comprising a mixture of an electrically conductive additive and a polymer on the carbon-nanotube layer.

13. The method according to claim 11, wherein the substrate comprises an electrically conductive metal selected from stainless steel, aluminum, copper, and combinations thereof.

14. The method according to claim 11, wherein the substrate has a thickness of 0.01˜3 mm.

15. The method according to claim 11, wherein the formation of a carbon-nanotube layer comprises growing the carbon nanotubes to a thickness of 1˜500 μm on the surface of the substrate by performing chemical vapor deposition for 2 to 60 minutes.

16. The method according to claim 11, wherein the polymer comprises a material selected from an epoxy resin, a phenolic resin, a furan resin, vinyl ester, polypropylene, polyvinylidene fluoride, polyethylene, polyphenylene sulfide, polyphenylene oxide, polyaniline, polypyrrole, and combinations thereof.

17. The method according to claim 11, wherein the polymer comprises a material exhibiting thermal resistance to temperatures from 10˜200° C.

18. The method according to claim 11, wherein the electrically conductive additive is mixed with the polymer in the composite layer and is electrically connected to the carbon nanotube layer.

19. The method according to claim 11, wherein the electrically conductive additive comprises a material selected from carbon black, graphite, carbon fiber, carbon nanotubes, Ag-coated copper, and combinations thereof.

20. The method according to claim 11, wherein the composite layer is formed by one selected from painting, screen coating, dipping, and tape casting.

21. The method according to claim 11, wherein the electrically conductive additive comprises 30˜60 weight % and the polymer comprises 40˜70 weight % with respect to a total weight of the mixture of the electrically conductive additive and the polymer.

22. The method according to claim 11, wherein the composite layer has a thickness of 10 μm˜3 mm.

23. The method according to claim 11, wherein the separator has a contact resistance of 10˜100 mΩ cm².

24. The method according to claim 11, wherein the separator has a bending strength of 56 MPa or more.
